(19) United States
(12) Patent Application Publication
(10) Pub. No.: US 2026/0036170 A1
(43) Pub. Date: Feb. 5, 2026

(54) METHOD FOR REDUCING FRICTION IN A ROLLING BEARING, IN PARTICULAR IN A VEHICLE WHEEL HUB BEARING, AND ASSOCIATED ROLLING BEARING

(71) Applicant: AKTIEBOLAGET SKF, GOTEBORG (SE)

(72) Inventors: Alessandro FERRERO, Torino (IT); Riccardo NARDICCHIA, Torino (IT); Fabio BOGLIACINO, Corneliano d’Alba (IT)

(21) Appl. No.: 19/280,220

(22) Filed: Jul. 25, 2025

(30) Foreign Application Priority Data
Aug. 1, 2024 (IT) 102024000018106

(51) Int. Cl. F16C 33/66; F16C 19/18

(52) U.S. Cl. CPC F16C 33/6688; F16C 19/181; F16C 2326/02

(57) ABSTRACT

A rolling bearing, in particular of a wheel hub bearing unit for vehicles, and an associated method for reducing the friction between the rolling bodies of the bearing and respective raceways for the rolling bodies formed on the inner and outer rings of the rolling bearing. The rolling bodies and the raceways have a surface topography of a predetermined thickness, the rolling bodies and/or the raceways are coated with a layer of black oxide, and a lubricating fluid with predetermined physical/chemical characteristics is inserted between the inner and outer rings and in contact with the rolling bodies and with the raceways.

### CROSS-REFERENCE

This application claims priority to Italian patent application no. 102024000018106 filed on Aug. 1, 2024, the contents of which are fully incorporated herein by reference.

### BACKGROUND OF THE INVENTION

The present invention relates to bearings, and more particularly to a method for the surface treatment of surfaces of components of a rolling bearing and a rolling bearing in a vehicle wheel hub bearing unit.

European patent no. EP2222892B1 discloses a chemical treatment method which can be applied to surfaces of large-size bearings, for example for wind turbine blades and/or rolling surfaces which are subject to high mechanical stresses, as in the case of constant-velocity joint components.

With the chemical treatment described in EP2222892B1, it is possible to obtain on the treated surfaces a thin layer of metal oxides, in particular iron oxides, known as “black oxide” (in short “BO”). The layer of BO makes the sliding/rolling surface more resistant to wear, since black oxide is very dense and compact and therefore able to absorb the mechanical stresses and protect at the same time the underlying metal from contaminating substances, such as alkaline or acid substances which may cause corrosion.

International patent publication no. WO2021139973A1 discloses an improvement of the method described in EP2222892B1 so as to increase the mechanical resistance of black oxide by means of deposition of further components, such as tungsten oxides in the BO layer.

In the case of rolling bearings designed for vehicles, in particular those forming part of a wheel hub bearing unit of motor vehicles, the need to increase the wear resistance of the rolling components of the bearings is less pressing, while there is an increasingly urgent need to reduce as far as possible the friction which is generated in the rolling bearing during normal operation, in order to reduce the energy consumption. The reduction in energy consumption has become a critical aim in connection with applications for electric traction vehicles.

In fact, in this type of application of the rolling bearing, the rolling elements such as balls or rollers not only undergo rolling friction, but are also subject to combined rolling and sliding conditions. That is, in a motor vehicle wheel bearing forming the wheel hub unit, or part thereof, the relative movement of rolling bodies and rolling/sliding tracks results in a mixed friction behaviour, which encounters rolling and sliding conditions, with a sliding/rolling ratio of between about 0% and 15% (where 0% is understood as being a pure rolling condition, while 100% is understood as meaning complete sliding conditions).

Therefore, there exists the need to reduce the friction in rolling bearings and, in particular, in those of vehicle wheel hub bearing units, all the more since this aim cannot be achieved by simply using high-performance lubricants, because on the one hand this measure is not sufficient and, on the other hand, the chemical additives contained in the high-performance lubricants may result in corrosion of the rolling components of the bearing.

### SUMMARY OF THE INVENTION

The object of the present invention is to provide a method for reducing the friction in rolling bearings, in particular in rolling bearings of a vehicle wheel hub bearing unit, which is simple and low-cost to implement and has a proven efficiency. It is also an object of the invention to provide an associated rolling bearing with a low degree of friction made using the aforementioned method.

The present invention provides a method for reducing the friction in rolling bearings, in particular in rolling bearings of vehicle wheel hub bearing units, and an associated rolling bearing, having the characteristic features described in the attached claims.

More particularly, the invention consists in the application of a treatment consisting in the deposition of black oxide over the whole surface of rolling bodies and/or on the raceways for the rolling bodies in a rolling bearing, in particular of the type intended for/forming a wheel hub bearing unit, which can be used in a synergistic manner in combination with specific chemical/physical characteristics of the lubricant used inside the rolling bearing and also in combination with selected surface topography parameters of the rolling elements, i.e. both the rolling bodies and the raceways for the rolling bodies, such as the roughness, in order to obtain an improved performance in terms of low friction and long working life of the rolling bearing.

In fact, it has been established in experimental tests carried out that the improvement obtained in terms of a reduction in the friction appears to be associated with an improved adhesion of the lubricating oil related to the improved wettability of the surfaces treated with black oxide coatings, due to the appropriate selection of the other parameters (characteristics of the lubricating oil and geometry of the treated surfaces).

### BRIEF DESCRIPTION OF THE SEVERAL VIEWS OF THE DRAWINGS

The invention will now be described with reference to the attached drawings which illustrate a non-limiting example of embodiment thereof, in which:

FIG. 1 shows in schematic form a radially sectioned view of a wheel hub bearing unit formed by a rolling bearing, the outer and inner rings of which are provided with attachment flanges; and

FIG. 2 shows, again only in schematic form, a view on a larger scale of a detail of

### DETAILED DESCRIPTION OF THE INVENTION

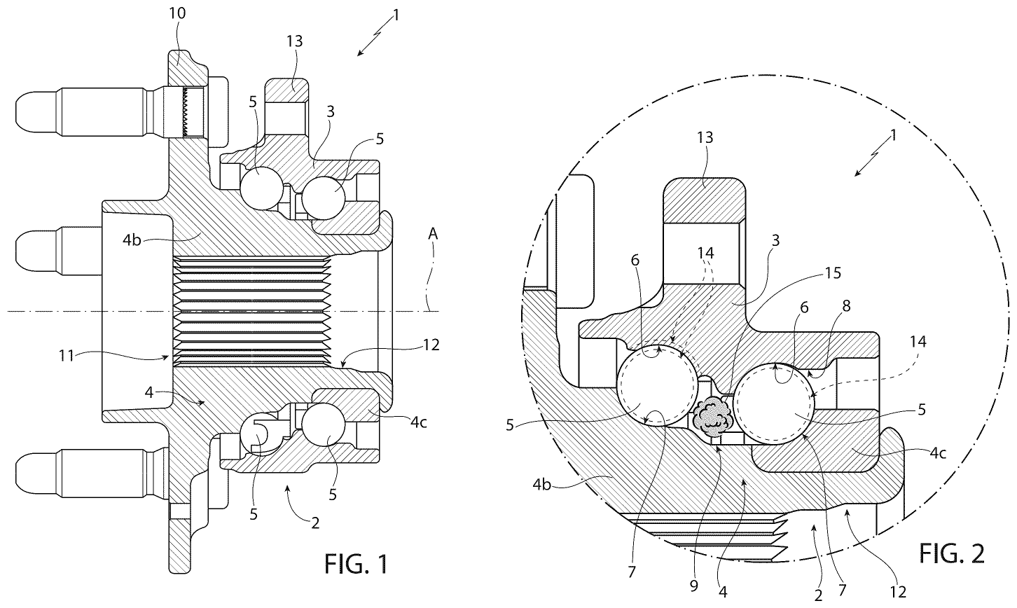

FIG. 1 showing in broken lines one of the components of the invention.

With reference to FIGS. 1 and 2, the reference number 1 denotes overall a wheel hub bearing unit for vehicles, consisting in the non-limiting example shown of a rolling bearing 2, of the so-called “double-flanged” type.

The rolling bearing 1 comprises a radially outer ring 3, a radially inner ring 4 and a plurality of rolling bodies 5. In the non-limiting example shown, the rolling bodies 5 consist of balls, but the description which follows is also applicable to a rolling bearing with rolling bodies consisting of all the types tapered rollers, cylindrical rollers, needles or any other appropriate type of rolling elements.

The rolling bodies 5 are interposed or disposed between the outer ring 3 and the inner ring 4 so that they are relatively rotatable about a common axis of symmetry A of the inner ring 4 and the outer ring 3.

The rolling bodies 5 (see FIG. 2) engage with respective annular raceways 6, 7 facing each other and formed respectively on a radially inner side surface 8 of the outer ring 3 and on a radially outer side surface 9 of the inner ring 4.

In the non-limiting example shown, the rolling bearing 2 consists of two rows of rolling bodies 5 arranged alongside each other, in the depicted embodiment two rows of balls, and therefore includes a pair of outer annular raceways 6 arranged alongside each other in tandem and facing a corresponding pair of inner annular raceways 7, also arranged alongside each other in tandem.

In the non-limiting example shown, the inner ring 4 is formed of two different elements which are coupled together, specifically a ring 4b provided with a radially outer attachment flange 10 for a vehicle wheel (not shown) formed integrally as one piece with the ring 4b at one end 11 of the ring 4b opposite to the outer ring 4, and a small inner ring (SIR) 4c mounted on one end 12 of the ring 4b opposite to the end 11 and radially inserted inside the outer ring 3. The small inner ring 4c is axially locked onto the end 12 in a known manner by means of upsetting of material at the end of the ring 4b.

The outer ring 3 also has a radially outer flange 13 for attachment to a suspension upright of a vehicle, known and not shown for simpler illustration.

According to other possible embodiments, not shown for simpler illustration, the rolling bearing 2 could be a normal rolling bearing with simple cylindrical rings 3 and 4, the latter ring being embedded on a spindle provided with a flange 10 and the former being inserted inside a support in turn integral with, or forming, the suspension upright of the vehicle, or provided always with the flange 13 for attachment to a vehicle suspension upright (not shown).

According to a first aspect of the invention, at least some or all of the contact surfaces of the so-called “ball set”, i.e. all the external surfaces of the rolling bodies 5 and/or the entire surface of the raceway(s) 6 and 7 for the rolling bodies 5, are internally coated with a layer 14 of black oxide of predefined thickness, shown in FIG. 2 by broken lines on the balls 5 and, for simpler illustration, only on a single raceway 6.

Moreover, the entire ball set must be in contact with a lubricating fluid 15, shown schematically in the form of a clump arranged between the balls 5, but in reality the lubricant forms a substantially uniform layer (not shown for simpler illustration) arranged on all the contact surfaces, in other words, all of the contact surfaces of the rolling bodies 5 and all of the contact surfaces of the raceways 6 and 7.

Black oxide is a thin layer of metal oxides, in particular iron oxides, which can be provided or formed on any steel surface according to the method taught in EP 2222892B1, the contents of which are incorporated herein by reference for any necessary disclosure contained therein. The layer 14 may also include other hard metal oxides, such as tungsten, in accordance with that taught by WO2021139973A1, the contents of which are incorporated herein by reference for any necessary disclosure contained therein.

In particular, the layer of black oxide 14 may contain at least 99% by weight of iron oxide in the form of a composite structure with the molecular formula Fe₃O₄ and a maximum of 0.5% by weight of free iron oxide with the molecular formula Fe₂O₃, which, however, is not a component of the composite structure. The layer of black oxide 14 is also made so as to be substantially impermeable.

In the bearing arts, layers of black oxide are normally only used for rolling bearing parts which have large dimensions and/or are subject to high mechanical loads, in order to prolong the life of the bearing due to the absorption by the black oxide layer of part of the mechanical loads.

According to the present invention, it has been surprisingly shown that the presence of very thin layers of black oxide on the contact surfaces of the ball set, when such black oxide layers are combined with a specific surface topology of these sliding surfaces and contact lubrication obtained with selected types of lubricating fluid, is able to greatly reduce the friction which develops during use of rolling bearings of any type, such that they have a low degree of friction, and, in particular, in those rolling bearings which are subject to mechanical and tribological stresses typical of vehicle bearings, as with wheel hub bearing units for vehicles such as the present wheel hub bearing unit 1, in which the rolling bodies 5 is subject mixed friction conditions, i.e. rolling friction and sliding friction.

Experimental tests have been conducted by the Applicant on rolling bearings with a double row of balls, the balls having a diameter of between 8 mm and 22 mm. In a first sample, ten bearings having balls entirely coated on their external surface with a layer of black oxide according to the invention, and in a second sample, ten identical bearings with balls devoid of a black oxide coating, using identical lubrication conditions and mechanical load conditions. The tests have shown that there is a surprising reduction in the friction, the reduction being equal to 50% for the bearings with balls coated with black oxide in zero load conditions and the reduction being equal to 25% in conditions where there is a load, in comparison with bearings which are identical but which have balls devoid of a black oxide coating.

In order to obtain such friction reductions, it has been established that the rolling bodies 5 must have a controlled surface roughness, preferably of between 0.02 microns and 0.08 microns and, in combination, the raceways 6 and 7 must also have a controlled surface roughness, preferably of between 0.05 microns and 0.15 microns.

Basically, the surface roughness of the raceways 6,7 must be slightly greater than that of the rolling bodies 5, in the experimental case in question, that of the balls 5.

In the case of rolling bodies 5 consisting of balls, it has also been established that other dimensional parameters, which may define surface topography parameters, must be present. For example, the roundness parameter of the balls must remain within 0.4 microns and 1 microns for ball diameters of between 8 and 22 mm.

Conversely, in the case of other types of rolling bodies 5, such as tapered rollers, with a diameter variable between 1 mm and 16 mm and a length of between 10 and 25 mm, the conicity (angle formed by the side surface of the roller with the axis of symmetry of the roller) must remain preferably within 1.5 degrees and 6 degrees.

Moreover, a suitable choice of lubricating fluid 15 to be arranged or provided between the inner ring 4 and the outer ring 3, and in contact with the rolling bodies 5 and with the raceways 6, 7, has also proved essential for obtaining the surprising result of a marked reduction in the friction as discussed above.

In particular, the lubricating fluid 15 present in the rolling bearing 2 is preferably a lubricating fluid with a synthetic base treated by hydrocracking and obtained by means of chemical synthesis from petroleum, or with a base formulated with PAO (polyalphaolefins), which must have the following characteristic parameters:
Viscosity range of the lubricating base of between 25-120 mm²/s at 40° C. according to DIN 51562, and 5-20 mm²/s at 100° C. according to DIN 51562;
Type of thickener: lithium complex, calcium complex or polyurea
Working penetration (60 shots, according to ISO 2137): maximum 305
Oil separation (at 40° C. for 1 week, according to DIN 51817): less than 4%
Surface tension of the oil base: between 25 and 35 mN/m (milli-Newtons per meter).

The layer of black oxide on the bearing 2 must have a very thin radial thickness of between 0.35 microns and 0.75 microns, which is much thinner than in previously known uses of black oxide layers.

Moreover, it has been found in experimental tests that, here also rather surprisingly, preferably only the external surfaces of all the rolling bodies 5 are coated with a layer 14 of black oxide, while the raceways 6, 7 have in combination a bare surface of hardened steel having the aforementioned surface roughness of between 0.05 and 0.15 microns.

Finally, further experimental tests carried out on bearings with two rows of rolling bodies 5, one of which is formed by a row of balls and the other one of which is formed by a row of tapered rollers, have shown that it is possible to obtain a reduction in the friction of about 10-15% also by coating with the layer 14 of black oxide the rolling bodies 5 of only one of the two rows of rolling bodies 5.

In a preferred embodiment of the invention, which is not shown for purposes of simpler illustration since it will be evident for the person skilled in the art from the description herein, the rolling bearing 2 has a row of balls 5 on the side of the end 11 of the ring 4b and a row of tapered rollers on the side of the end 12 of the ring 4b, i.e. the variant in question of the wheel hub bearing unit 1 has tapered rollers instead of the balls arranged on the right-hand side of FIG. 2; moreover, according to this embodiment, only the tapered rollers are coated with the layer 14 of black oxide, while the balls 5 are bare (i.e., with a layer of black oxide), it being understood that the other constructional parameters (roughness) and lubrication parameters described above are present in this embodiment.

In this embodiment, it has been surprisingly noted that the reduction in friction is equal to that which is obtained in the embodiment shown in FIG. 2, in which the rolling bearing 1 has two rows of balls and all of the balls of both rows of rolling bodies 5 are coated with a layer 14 of black oxide.

In other words, in the specific embodiment with one row of balls and one row of rollers, savings may be made on the treatment cost of the balls 5, with only the tapered rollers being treated, and the same end result may be achieved.

From that disclosure above, it is clear that the invention also extends to a method of reducing friction in rolling bearings, in particular, in rolling bearings 2 of a wheel hub bearing unit 1 of vehicles, where the rolling bearing 2 comprises a radially outer ring 3, a radially inner ring 4 and a plurality of rolling bodies 5 interposed/disposed between the outer ring 3 and the inner ring 4 so that they are relatively rotatable about a common axis of symmetry A of the inner ring 4 and outer ring 3, the rolling bodies 5 engaging with respective annular raceways 6, 7 facing each other and formed respectively on a radially inner side surface 8 of the outer ring 3 and on a radially outer side surface 9 of the inner ring 4.

According to the main aspect of the invention, the friction reduction method comprises the following steps:
a) providing or forming the rolling bodies 5 and the raceways 6, 7 with predetermined geometric surface topography parameters by means of suitable machining, for example lapping, polishing or barrel-polishing;
b) subjecting all the rolling bodies 5 of at least one row of rolling bodies, in the case of rolling bearings with two rows of rolling bodies, and/or at least one or both the raceways 6 and 7, after step a) and before insertion of the rolling bodies 5 between the inner ring 4 and outer ring 3 for coupling with the raceways 6, 7, to a black oxide deposition step until the rolling bodies 5 and/or one or both of the raceways 6, 7 are completely coated with a layer 14 of black oxide of a predetermined thickness; and
c) inserting between the inner ring 4 and outer ring 3 and in contact with the rolling bodies 5 and with the raceways 6, 7 a lubricating fluid 15 with predetermined physical/chemical characteristics.

Step b) (i.e., the black oxide deposition) is performed using the method disclosed in EP 2222892B1, optionally improved according to WO 2021139973A1, until a substantially uniform layer 15 of back oxide with a radial thickness of between 0.7 microns and 1.5 microns is obtained.

Moreover, step a) is performed so as to obtain or provide a surface roughness of the rolling bodies 5 (whether balls, rollers, etc.) of between 0.02 microns and 0.08 microns and, in combination, a surface roughness of the raceways 6, 7 of between 0.05 microns and 0.15 microns.

The rolling bodies 5 and the raceways 6, 7 for the rolling bodies 5 must be made of hardened steel and must be heat-treated so as to have, in combination: the rolling bodies 5, a surface hardness of between 65 HRC and 70 HRC (Rockwell C degrees) and a core hardness of between 62 HRC and 68 HRC; and the raceways 6, 7, a surface hardness of between 59 HRC and 62 HRC in the case where the inner ring 4 and outer ring 3 have been completely hardened, and of between 680 HV and 800 HV (Vickers degrees) where the inner ring 4 and outer ring 3 have been hardened only along the raceways 6, 7, preferably by means of induction hardening.

Moreover, the lubricating fluid 15 which is inserted between the inner ring 4 and outer ring 3 and in contact with the rolling bodies 5 and with the raceways 6, 7 in step c) must be chosen from the group consisting of: lubricant with a hydrocracking-treated synthetic base obtained by means of chemical synthesis from petroleum or lubricant with a base formulated with PAO (polyalphaolefins).

In particular, the lubricating fluid 15 is chosen so as to have the following parameters, all in combination with each other:
Viscosity range of the lubricating base: between 25-120 mm²/s at 40° C. according to DIN 51562, and 5-20 mm²/s at 100° C. according to DIN 51562;
Type of thickener: lithium complex, calcium complex or polyurea
Working penetration (60 shots, according to ISO 2137): maximum 305
Oil separation (at 40° C. for 1 week, according to DIN 51817): less than 4%
Surface tension of the oil base: between 25 and 35 mN/m (milli-Newtons per meter).

According to a further characteristic feature of the invention, the rolling bearing 2, once the inner ring 4 and outer ring 3 have been assembled with the rolling bodies 5, is not completely ready to obtain the surprising reduction in friction encountered during experimental tests, but must be first subject to a run-in phase, preferably of between 2 and 3 hours, until a reduction in radial thickness of the layer 14 of black oxide of at least about 50% is obtained, so as to achieve the greatly reduced thicknesses of the layer 14.

The advantage of low friction is also ensured among the elements in sliding conditions, due to the improved and stable lubricating film, also in the presence of sliding movements and not only rolling movements. Examples of sliding conditions in a rolling bearing for a wheel hub unit 1 according to the invention are:
relative movement of the rolling bodies and pockets of the cage containing the rolling bodies;
relative movement of the edges of roller rolling bodies and guide flange surface on the rings, in the case of bearings with tapered rollers.

In the case of rolling bearings 2 with two rows of rolling bodies, in which one of the two rows is consists of balls and the other one consists of tapered rollers, step b) is preferably performed only on all the rolling bodies 5 consisting of tapered rollers, while leaving the balls untreated.

The improvement in the low friction (rolling and sliding friction) is increased after a run-in phase (for example 3 hours at 900 rpm under load, as for example in the case of a car wheel bearing) where the layer of black oxide may lose about 50% of its thickness, which reduces the manufacturing roughness of the metal components. However, the black oxide conversion layer 14 remains present and functional for the entire working life of a vehicle.

The friction wear performance of the raceways in poor lubrication conditions is improved by up to 25%; consequently, the depths of the “false brinelling” marks on the vehicle applications are reduced, which is particularly important during the transport of the vehicles over long distances and/or in cold conditions, especially in the case of heavy vehicles, such as SUVs.

The layer of black oxide also acts as a chemical barrier for protection against harmful lubricating additives, thereby increasing the possibilities of using high-performance lubricants, which are currently not suitable for applications involving bearings for vehicle wheel hub bearing units.

One of the advantages of black oxide compared to other types of coatings consists in the fact that it creates a conversion layer which is firmly connected to the base material and influences in a substantially negligible manner the dimensions of the metal component, so that additional or preliminary machining operations, which could negatively affect the final result, are not necessary.

A layer of black oxide, moreover, even if worn does not damage the performance of the bearing since it is not a hard layer extraneous to the material of the bearing itself.

An advantage of black oxide, when applied onto rolling elements 5, is that the rolling elements 5 may be treated superficially in a location other than the final assembly plant, they may be despatched or shipped in bulk in packs and handled without particular care, without the risk of flaking, removal or deterioration in the performance of the coating. A minimum degree of oiling of the surfaces is sufficient for correct despatch and conservation of the metal components.

The treatment with black oxide also has slight anti-corrosion properties which are useful during the storage and despatch of the final product and in order to improve the overall life of the bearing (for example if the internal rolling elements are exposed to moisture).

All the objects of the invention are therefore achieved.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A method of reducing friction in rolling bearings of wheel hub bearing units of vehicles, the rolling bearing including a radially outer ring, a radially inner ring and a plurality of rolling bodies interposed between the outer ring and the inner ring so as to make them relatively rotatable about a common axis of symmetry of the inner and outer rings, the rolling bodies engaging with respective annular raceways facing each other and formed on a radially inner side surface of the outer ring and a radially outer side surface of the inner ring, the method comprising the steps of:
machining the rolling bodies and the raceways to obtain predetermined geometric surface topography parameters;
after machining the rolling bodies and the raceways and before insertion of the rolling bodies between the inner and outer rings, subjecting all of the rolling bodies of at least one row of rolling bodies and/or at least one raceway to a black oxide deposition process until the rolling bodies and/or the at least one raceway is/are completely coated with a layer of black oxide of a predetermined thickness; and
inserting a lubricating fluid with predetermined physical or chemical characteristics between the inner and outer rings and in contact with the rolling bodies and the raceways.

2. The method according to claim 1, wherein during the step of the black oxide deposition process, a layer of black oxide with a radial thickness of between 0.7 microns and 1.5 microns is deposited.

3. The method according to claim 1, wherein the step of machining the rolling bodies and the raceways obtains a surface roughness of the rolling bodies of between 0.02 microns and 0.08 microns and a surface roughness of the raceways of between 0.05 microns and 0.15 microns.

4. The method according to claim 1, wherein the rolling bodies and the raceways are made of a hardened steel and are heat-treated such that the rolling bodies have a surface hardness of between 65 HRC and 70 HRC and a core hardness of between 62 HRC and 68 HRC and the raceways have a surface hardness of between 59 HRC and 62 HRC when the inner and outer rings have been fully hardened or a surface hardness of between 680 HV and 800 HV when the inner and outer rings have been hardened only along the raceways.

5. The method according to claim 4, wherein when the inner and outer rings have been hardened only along the raceways, the hardening is performed by induction hardening.

6. The method according to claim 1, wherein the lubricating fluid inserted between the inner and outer rings and in contact with the rolling bodies and with the raceways is a lubricant with a hydrocracking-treated synthetic base obtained by means of chemical synthesis from petroleum or a lubricant with a base formulated with polyalphaolefins.

7. The method according to claim 6, wherein the lubricating fluid is selected to have the following combination of parameters:
a viscosity range of the lubricating base of between 25-120 mm²/s at 40° C. according to DIN 51562 and 5-20 mm²/s at 100° C. according to DIN 51562;
a thickener type of lithium complex, calcium complex or polyurea;
a working penetration (60 shots, according to ISO 2137) of a maximum 305;
oil separation (at 40° C., for 1 week, according to DIN 51817) of less than 4 percent; and
a base oil surface tension between 25 and 35 mN/m (milli-Newtons per meter).

8. The method according to claim 1, wherein the rolling bearing is subjected to a run-in phase preferably for a duration of between 2 and 3 hours at 900 rpm after assembly of the inner and outer rings with the rolling bodies until the radial thickness of the black oxide layer is reduced by about 50 percent.

9. A low-friction rolling bearing of a wheel hub bearing unit for vehicles, the rolling bearing comprising:
a radially outer ring with a radially inner surface and at least one annular raceway formed on the radially inner surface;
a radially inner ring with a radially outer surface and at least one annular raceway formed on the radially outer surface and facing the at least one raceway of the outer ring; and
a plurality of rolling bodies interposed between the outer ring and inner ring so as to make the outer and inner rings relatively rotatable about a common axis of symmetry of the inner and outer rings, the rolling bodies engaging with respective the annular raceway of the outer ring and the annular raceway of the inner ring;
wherein the rolling bodies of at least one row of the rolling elements and/or one or both of the annular raceways are fully coated with a layer of black oxide of predetermined thickness;
the rolling bodies have a surface roughness of between 0.02 microns and 0.08 microns and the raceways have a surface roughness of between 0.05 microns and 0.15 microns;
a lubricating fluid is disposed between the inner ring and outer ring and in contact with the rolling bodies and the raceways, the lubricating fluid having a hydrocracking-treated synthetic base obtained by means of chemical synthesis from petroleum or with a polyalphaolefin formulated base and having the following characteristic parameters:
the base has a viscosity range between 25-120 mm²/s at 40° C. according to DIN 51562 and 5-20 mm²/s at 100° C. according to DIN 51562;
a thickener being one of a lithium complex, a calcium complex or a polyurea;
working penetration (60 shots, according to ISO 2137) of a maximum 305;
oil separation (at 40° C., for 1 week, according to DIN 51817) of less than 4%; and
base oil surface tension of between 25 mN/m and 35 mN/m.

10. The low-friction rolling bearing according to claim 9, wherein the layer of black oxide has a radial thickness of between 0.35 microns and 0.75 microns.

11. The low-friction rolling bearing according to claim 9, wherein all of the rolling bodies of at least one row of rolling elements are coated with the layer of black oxide and the raceways have a bare surface of hardened steel with the surface roughness of between 0.05 microns and 0.15 microns.

12. The low-friction bearing according to claim 11, wherein the rolling bearing includes a first row of rolling bodies consisting of balls and a second row of rolling bodies consisting of tapered rollers, only the rolling bodies of the second row of rolling bodies being completely coated with the layer of black oxide.
